(19) United States
(12) Patent Application Publication
(10) Pub. No.: US 2002/0040923 A1
(43) Pub. Date: Apr. 11, 2002

(54) Contact structure for connecting two substrates and also process for producing such a contact structure

(75) Inventors: Jurgen Schredl, Berlin (DE); Thomas Oppert, Berlin (DE)

Correspondence Address: McGLEW AND TUTTLE, John James McGlew, Scarborough Station, Scarborough, NY, 10510-0827, US

(73) Assignee: Pac Tech-Packaging Technologies GmbH

(21) Appl. No.: 10/020,594

(22) Filed: Dec. 13, 2001

Related U.S. Application Data
(62) Division of application No. 09/485,426, filed on Feb. 8, 2000.
Application No. 09/485,426 is a 371 of international application No. PCT/DE98/02067, filed on Jul. 23, 1998.

(30) Foreign Application Priority Data
Aug. 8, 1997 (DE) 197 34 442.9
May 20, 1998 (DE) 198 22 559.8

(51) Int. Cl. B23K 31/02

(52) U.S. Cl. 228/248.1; 228/180.22

(57) ABSTRACT

A contact structure (10) and a process for producing a contact structure are provided for connecting two substrates (11, 12). The process includes applying solder material (23) to terminal areas (16) of a first substrate (11) to form spacing metallizations (19), and bonding of the first substrate (11) with a second substrate (12). The bonding between the terminal areas (16) of the first substrate (11) and a contact surface area of the second substrate (12) is performed by means of an electrically conductive adhesive compound (20).

### RELATED APPLICATIONS

This is a Divisional of application Ser. No. 09/485,426 filed Feb. 8, 2000, and the entire disclosure of this prior application is considered to be part of the disclosure of the accompanying application and is hereby incorporated by reference therein.

### FIELD OF THE INVENTION

The present invention relates to a contact structure for connecting two substrates having a spacing metallization disposed on a terminal area of the first substrate as well as a substrate arrangement with a first substrate and a second substrate and a plurality of contact structures and a process for producing a contact structure for connecting two substrates.

### BACKGROUND OF THE INVENTION

In bonding substrate arrangements by the so-called “flip-chip procedure”, in which a chip or even a chip module is, as a rule, bonded by means of its terminal areas and a structure, situated in between, of contact metallizations on terminal areas of a contact surface of a subassembly printed circuit board or the like, extremely high contact densities are possible relative to the surface area of the chip or the surface area of the chip module. In this structure, the level of the contact density is essentially determined concomitantly by the minimum spacing which has to be maintained between the individual contact structures in order to prevent the occurrence of short circuits. In particular, in those cases in which contact structures are to be made only between some of the mutually oppositely situated terminal areas, that is to say a selective bonding is to be made, it proves, in addition, to be essential to maintain a necessary minimum spacing not only in the contact plane to avoid short circuits, but, in addition, also between the mutually oppositely situated contact surface areas of the substrates. This is the case, for example, if 2L chip provided with additional test terminals on its contact surface area is to be bonded to a further substrate without the test terminals also being included under those circumstances in the bonding.

To form contact structures which, in addition to an electrically conductive connection between the terminal areas of the two substrates, also make possible the formation of a spacing between the substrate surface areas, it is known to form on the terminal areas of the one substrate raised contact metallizations, so-called “bumps”, which are fused to produce the electrical contact, with simultaneous formation of mechanical retaining forces to secure the contact. As a result of the fusion, a redistribution of the material volume of the raised contact metallizations occurs, with the consequence that the height of the contact metallizations and, consequently, the spacing defined by the height of the contact metallizations between the substrate surface areas is reduced.

Simultaneously, because of the volume redistribution of the contact metallizations as a consequence of the fusion, a reduction in the spacing between the individual contact metallizations may occur.

### SUMMARY AND OBJECTS OF THE INVENTION

The object of the present invention is to provide a contact structure using raised contact metallizations for connecting two substrates in which arrangement the spacing function of the contact metallizations is not impaired by the connecting operation.

According to the invention, a contact structure is provided for connecting two substrates having a spacing metallization disposed on a terminal area of the first substrate. An electrically conductive adhesive compound is provided for joining the spacing metallizations to the second substrate.

In the contact structure according to the invention, an electrically conductive adhesive compound is provided for connecting the spacing metallization to the second substrate.

In contrast to the known raised contact metallization, in the contact structure according to the invention, the spacing metallization serves solely to form a spacer whose height is defined and which makes possible an electrically conductive contact between the substrates. The mechanical retaining forces necessary to secure the conducting electrical contact are not formed by a material-looked connection between the material of the spacer or by the formation of surface forces as a consequence of wetting, as is the case for the known remelting, but, on the contrary, by disposing an adhesive compound situated in between. To achieve an electrical conductivity, said adhesive compound is made electrically conductive, for example, by adding electrically conductive particles.

The contact structure according to the invention makes it possible to dispose the material volume used for the formation of the spacing metallization in its amount and/or shape in such a way as appears suitable for achieving the pure spacing function without being influenced by a subsequent fusion operation, If the spacing metallization is formed from a solder material, in addition to the spacing function, benefits can also be achieved advantageously from the plastic deformation behavior of the solder material for reducing stresses, as a rule thermally induced, between the substrates.

If an intermediate metallization is advantageously provided between the terminal area of the first substrate and the spacing metallization, it is possible to choose even those materials which cannot be directly bonded to the terminal area of the first substrate for forming the spacing metallization.

Thus, for instance, the use of a nickel-containing and gold-containing alloy to form the intermediate metallization offers the advantageous possibility of forming the spacing metallization from conventional solder material, such as, for example, a lead/tin alloy, which, if bonded directly to an aluminum terminal area of the first substrate, would result only in inadequate mechanical retaining forces.

In a substrate arrangement that can be produced using the contact structure according to the invention, some of the contact structures are formed, according to the invention, between terminal areas of the first substrate and terminal areas of the second substrate and others between terminal areas of the first substrate and electrically inactive surface area regions of the second substrate. In this connection, the contact structures assigned to the electrically inactive surface area regions serve as pure spacers and have no electrical function. The substrate arrangement according to the invention consequently offers the advantage of making it possible to utilize all the terminal areas of the first substrate to form spacing metallizations without a terminal area of the second substrate having to be assigned in each case to the terminal areas of the first substrate. As a result, a mechanical support or the formation of a spacer is possible also in regions of the second substrate in which no terminal areas are provided and that are consequently electrically inactive.

The process according to the invention may have the following process steps:

application of solder material to terminal areas of a first substrate to form spacing metallizations, and

bonding of the first substrate to a second substrate, the bonding between the terminal areas of the first substrate and a contact surface area of the second substrate being performed by means of an electrically conductive adhesive compound.

Owing to the use of a conductive adhesive material in conjunction with the spacing metallizations that serve to achieve a defined spacing between the substrates to be mutually connected, the process according to the invention makes it possible to produce a mechanical connection between the two substrates, regardless of whether a mating terminal area is assigned to each terminal area of the first substrate on the contact surface area of the second substrate or not. In the absence of the assignment of a mating terminal area on the contact surface area of the second substrate, an at least mechanical connection to the contact surface area of the second substrate can be made in the same way as in bonding two mutually oppositely situated terminal areas. As a result, it is possible to use one and the same process both to produce electrically active contact structures and to produce electrically inactive contact structures that have solely a mechanical retaining function. In the case of the above procedure, it is possible to form the spacing metallizations on a chip and the adhesive coating between the spacing metallizations and the contact areas of a chip carrier or, alternatively, the adhesive coating on the contact areas of the chip and the spacing metallizations on the contact areas of the chip carrier.

An alternative process according to the invention comprises the following process steps:

application of solder material to terminal areas of a first substrate to form spacing metallizations, and bonding of the first substrate to a second substrate, the bonding between the terminal areas of the first substrate and a contact surface area of the second substrate being performed by means of a partial fusion of the spacing metallizations.

Preferably, the spacing metallizations are partially fused by means of laser energy in order to facilitate as discrete an introduction as possible of the energy, which introduction leaves that essential part of the spacing metallizations that fulfils the spacing function in its solidified state.

If the terminal areas are provided with an intermediate metallization prior to the application of the solder material to the terminal areas, it is possible to use even those solder materials for forming the spacing metallizations with which a wetting of the terminal area surface adequate for the formation of retaining forces between the surface areas and the spacing metallizations would otherwise not be possible.

It proves particularly advantageous to form the spacing metallizations in a spherical shape or meniscus shape since the spherical shape forms as it were automatically in a remelting process because of the surface tension of the molten solder material without a special shaping process or a special shaping tool being necessary. At the same time very varied processes are available for producing the spherical shape. Thus, for example, it is possible to reshape the pasty solder material associated with the individual terminal areas of the first substrate as a consequence of a mask application to a spherical shape as a result of fusion. On the other hand, there is the possibility of applying separate solder material moldings to the terminal areas and remelting them there, in particular, to form the spherical shape. It is also possible to remelt solder material moldings beforehand, for example, by using a so-called “ball bonder” and then to bond on the terminal areas while retaining the shape. Regardless of the particular shape formation, the important thing in forming the spacing metallizations is to produce a shape which makes possible the spacing function.

The electrically conducting adhesive material can be applied either to the spacing metallizations of the first substrate or to the contact regions or surface regions of the second substrate provided for bonding to the spacing metallizations. In this connection, an application device may be employed which, in the case of the application of the adhesive material to the spacing metallizations, can be formed in a mobile manner relative to the spacing metallizations. Such an application can be performed, for example, using a movable dispensing device for adhesive material with which adhesive points can be applied to the spacing metallizations. The application may also be performed by transfer from an area wetted with adhesive material, for example the tip of an application needle.

It proves particularly advantageous to apply the adhesive material by immersing the spacing metallizations in a volume of conductive adhesive material. In this connection, the nature of the volume of adhesive may be such that a uniform surface is provided for the immersion process of all the spacing metallizations or that individual volumes of the adhesive material are provided that are associated with each spacing metallization. It may be pointed out that the term “immersion” is to be understood here as meaning that a process is described in which at least a subregion of the surface of the spacing metallization is wetted with the adhesive material by manipulating the first substrate and performing a relative movement with respect to the volume or volumes of adhesive.

It is also possible to apply the adhesive compound to the contact areas provided for bonding to spacing metallizations, in particular the chip contacts and/or the inactive surface regions of the second substrate. Such an application may be performed, for example, in a template application process or by means of screen printing.

Particularly in connection with the wetting of the spacing metallizations with adhesive material by manipulating the first substrate relative to a stationary volume of adhesive, as described above, it proves advantageous also to perform the subsequent bonding of the first substrate to the second substrate by manipulating the first substrate. As a result, it is in fact possible to use a device suitable for manipulating the first substrate both to apply the adhesive material to the spacing metallizations and also to perform the actual bonding of the first substrate to the second substrate, that is to say to make the electrically conductive connection between the substrates.

If a gap remaining between the substrate surfaces after the two substrates have been bonded is filled with a filler material, it is possible, on the one hand, to stabilize the substrate arrangement and, on the other hand, to achieve a sealing of the sensitive contact regions between the substrate surfaces from the outside. Such a filling of the gap proves advantageous, in particular, if the first substrate, that is to say, for example, the chip, as a deformation-resistant substrate is bonded to a flexible second substrate, that is to say, for example, a substrate having a film carrier.

If the filler material filled into the gap between the two substrates serves not only to support or reinforce the substrate arrangement, but also to produce a mechanical retaining joint between the two substrates, it is possible to use for the conductive adhesive material adhesive material that is active only temporarily or adhesive material that has only low and, if necessary, releasable adhesive forces, such as is the case, for example, for so-called pressure-sensitive adhesives which serve to produce temporary adhesive joints which can easily be released.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a partially sectional view of the contact structure between a chip and a coil substrate for forming a transponder;

FIG. 2 is a schematic perspective view showing the substrate arrangement comprising a chip and a chip carrier for producing a chip module;

FIG. 3 is a side view showing a process stage for producing the substrate arrangement shown in FIG. 2;

FIG. 4 is a side view showing a process stage for producing the substrate arrangement shown in FIG. 2;

FIG. 5 is a side view showing a process stage for producing the substrate arrangement shown in FIG. 2;

FIG. 6 us a side view showing a stage of a variation of the process shown in FIGS. 3 to 5 for producing the substrate arrangement shown in FIG. 2; and

FIG. 7 us a side view showing a stage of a variation of the process shown in FIGS. 3 to 5 for producing the substrate arrangement shown in FIG. 2.

### DESCRIPTION OF THE PREFERRED EMBODIMENT

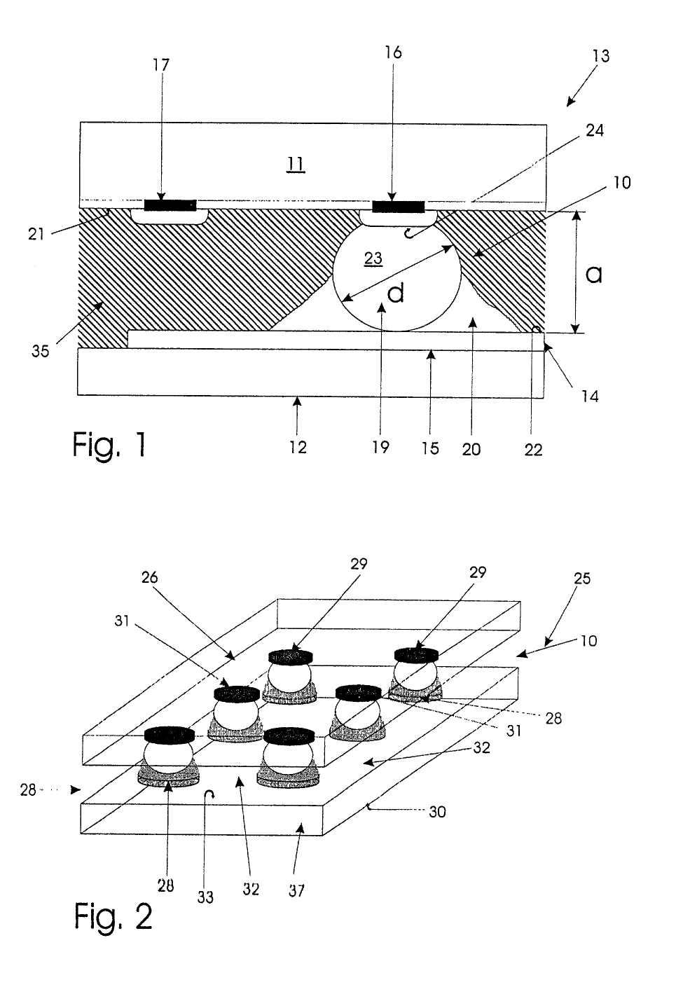

Referring to the drawings in particular, FIG. 1 shows the formation of a contact structure 10 in the case of a substrate arrangement formed from a chip 11 and a coil substrate 12 for forming a transponder 13. Such transponders 13 are used for contact-free data transfer and have, as essential functional elements, the chip 11 and also an aerial coil 14 formed on the coil substrate 12. In the present case, the aerial coil 14 is formed as a wire, coil with coil wire ends 15 that are each connected both in an electrically conducting manner and in a mechanically retaining manner via a contact structure 10 with an associated chip terminal area 16. Terminal ends of etched or printed coils can likewise be bonded in the above manner. Of a plurality of contact structures 10 only one is shown in FIG. 1.

In addition to chip terminal areas 16, which serve to bond electrically to the aerial coil 14, the chip 11 has additional test terminals 17, of which only one test terminal 17 is shown in FIG. 1, which serve to test the chip 11 electrically prior to bonding to the aerial coil 14 and which acquire no additional function after the chip 11 has been bonded to the aerial coil 14.

As can be seen from FIG. 1, the contact structure 10 between the chip terminal area 16 and the coil wire end 15 is made up of three components, namely an intermediate metallization 18, a spacing metallization 19 and a conductive adhesive compound 20. In the present case, a nickel-containing and gold-containing alloy that can be applied adhesively to the chip terminal area 16, for example, in an electroless metal deposition process is used for the intermediate metallization 18 applied directly to the aluminum terminal area 16 of the chip 11. The spacing metallization 19 is, on the other hand, formed from a conventional solder alloy, for example a low-m,elting lead/tin alloy. In the contact structure 10 shown in FIG. 1, not only the electrically conducting contact between the spacing metallization 19 and the coil wire end 15, but also the mechanical joint between the spacing metallization 19 and the coil wire end 15 is made by means of the adhesive compound 20. At the same time, the electrical connection is achieved by means of electrically conductive particles contained in the adhesive compound 20 and the mechanical joint is achieved by means of the adhesive forces acting in the adhesive compound.

From the diagram in accordance with FIG. 1, it furthermore becomes clear that, because of the combination of the adhesive compound 20 with the spacing metallization 19, a mechanically retentive, electrically conductive connection is-made possible between the spacing metallization 19 and the coil wire end 15 without affecting the spacing metallization 19 formed in the present case as a sphere. As a result, a spacing a made possible by the spacing metallization 19 between a contact surface 21 of the chip 1 1 and a contact surface 22 of the coil substrate 12, said contact surface 22 being formed in the present case by the surface of the coil wire end 15, can be substantially equated to the diameter d of the spherically shaped spacing metallization 19. This simplified assumption can be made in the present case since the intermediate metallization 18 serves, as is explained in still greater detail below, only to form a surface 24 which can be wetted with solder material 23 used to produce the spacing metallization 19.

FIG. 2 shows a substrate arrangement that is formed as chip module 25 and that comprises a chip 26 and a chip carrier 27. The chip carrier 27 is provided with a conductor track structure that is not shown here in greater detail and that makes possible a redistribution of the contact structure on an external contact side 30 of the chip carrier 27 proceeding from chip contacts 28 of the chip carrier 27 on the chip contact side 33 that serve to bond to the chip terminals 29 of the chip 26.

The chip 26 shown in FIG. 2 comprises, in addition to the chip terminals 29 that serve to bond to the chip carrier 27 also two test terminals 31 that are not needed to connect the chip 26 to the chip carrier 27 and serve solely for electrically testing the components of the chip 26 prior to bonding.

As is evident from FIG. 2, the chip module 25 has, in the present case, a total of six contact structures IO that, as already described above with reference to FIG. 1, are made up of three components, namely the intermediate metallization 18, the spacing metallization 19 and the adhesive compound 20. At the same time, the contact structures 10 extending between the chip terminals 29 of the chip 26 and the chip contacts 28 of the chip carrier 27 serve both to make an electrically conductive connection and to produce a joint that mechanically holds the chip module 25 together. On the other hand, the contact structures 10 extending between the test terminals 31 of the chip 26 and electrically inactive surface regions 32 of the chip contact areas 33 of the chip carrier 27 serve only to produce a mechanical joint that holds the chip module 25 together.

As shown in FIG. 1, it is also possible in the case of the chip module shown in FIG. 2 to fill a gap 34 formed between the chip surface and the chip contact side of the chip carrier 27 with a filler material 35.

In particular, if a filler material 35 having adhesive properties is used to fill the gap 34, it is possible to form the adhesive joint achieved by means of the adhesive compound 20 of the individual contact structures 10 only temporarily or only with low adhesive forces in order then to achieve a permanently retentive joint between the chip 26 and the chip carrier 27 by means of the filler material 35. An electrically insulating, thermally activatable polymer is particularly suitable in the above case for use as filler material 35.

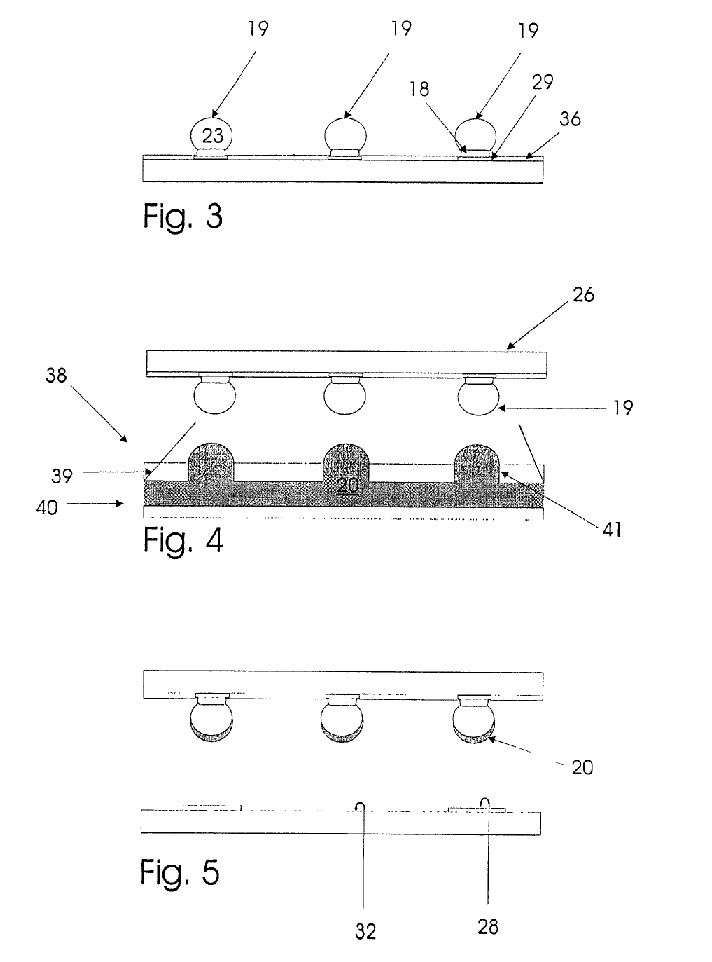

FIGS. 3 to 5 show below the procedure for producing the substrate arrangement shown in FIG. 2 and implemented here by way of example as chip module 25.

FIG. 3 shows the chip 26 having a passivation layer 36 that is disposed on its active surface and in which the chip connections 29 are disposed and are already provided in a preceding process step with the intermediate metallization 18. To form the spacing metallizations 19, a solder material 23 remelted into a spherical shape by fusion is also already situated on the respective intermediate metallizations 18. The solder material 23 can be applied to the intermediate metallizations 18 in various ways. Thus, it is possible, for example, to apply the solder material 19 to the intermediate metallizations 18 as a pasty material in a mask process and then to fuse it into a spherical shape to form the spacing metallizations 19. It is also possible to apply the solder material 23 already formed into solder material moldings, for example spheres, to the intermediate metallization 18 and subsequently join it to the intermediate metallizations 18 by applying energy with at least partial fusion. In addition, there is also the possibility of applying the spherically shaped spacing metallizations 19 directly, that is to say without disposing the intermediate metallization 18 in between, to the chip terminals 29, provided that the chosen metal composition makes possible an adequate wetting of the chip terminals 29 to form adequate retaining forces.

As is shown in FIG. 4, the adhesive compound 20 is subsequently applied to the spacing metallizations 19. To apply the adhesive compound 20 to the spacing metallizations 19 in the present case, in adhesive compound dispensing device 38 is used that has, in a masking device 39 of a receiving container 40, capillary bores 41 that, with suitable liquid pressure of the adhesive compound 20 contained in the receiving container 40, make possible the formation of liquid menisci 41 of the adhesive compound 20 on the masking device 39. To apply adhesive compound 20 to the spacing metallizations 19, the chip 26 with its spacing metallizations 19 is lowered, as shown in FIG. 4, onto the masking device 39 in such a way that the spacing metallizations 19 are wetted by the liquid menisci 41 and, when the chip 26 is removed from the masking device 39, an appropriate amount of the adhesive compound 20 continues to adhere to the spacing metallizations 19.

As shown in FIG. 5, to bond to the further substrate formed as chip carrier 27 by the flip-chip procedure, the chip 26 provided with adhesive compound 20 on its spacing metallizations 19 can now be lowered onto the chip contact side 33 of the chip carrier 27 in such a way that the adhesive compounds 20 disposed on the spacing metallizations 19 come into contact with the chip contacts 28 or the electrically inactive surface regions 32. This achieves the configuration in which the contact structures 10 are formed in accordance with the diagram in FIG. 2.

In this configuration, a thermal prefixing of the adhesive compounds 20 can be produced by suitably applying temperature and a permanent mechanical joint between the chip 26 and the chip carrier 27 can be made subsequently, for instance after filling the gap 34 (FIG. 2) with filler 35.

Furthermore, as becomes particularly clear from an overall view of FIGS. 2 and 5, as a result of using the adhesive compound 20 for bonding the spacing metallizations 19 to the chip contacts 28 or the electrically inactive surface regions 32, which in the present case are set back with respect to the chip contacts 28, it is readily possible to equalize spacing differences between the chip contact surface 21 of the chip and the chip contact side 33 of the chip carrier 27.

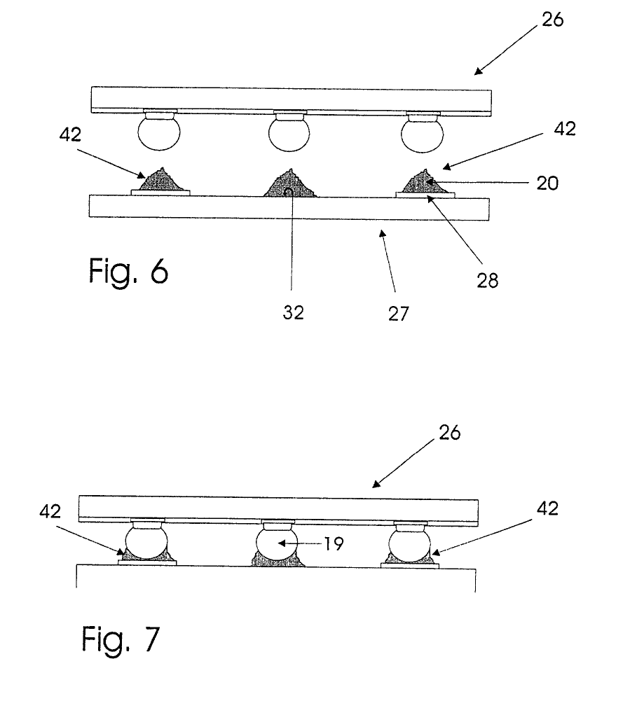

FIGS. 6 and 7 show a further possibility for the application of the adhesive compound 20 between the spacing metallizations 19 and the chip contacts 28 or the electrically inactive surface regions 32. In this case, in preparation for bonding the chip 26 to the chip carrier 27, the adhesive compound 20 is dispensed onto the chip contacts 28 or the electrically inactive surface regions 32 to form deposits 42 of adhesives using a dispensing device not shown here in greater detail. As FIG. 7 shows, the bonding is then achieved by inserting the chip 26 with its spacing metallizations 19 into the deposits 42 of adhesive by the flip-chip procedure.

While specific embodiments of the invention have been shown and described in detail to illustrate the application of the principles of the invention, it will be understood that the invention may be embodied otherwise without departing from such principles.

What is claimed is:

1. A process for producing a contact structure for connecting two substrates comprising the following process steps:
applying solder material to terminal areas of a first substrate to form spacing metallizations; and
bonding the first substrate with a second substrate, the bonding between the terminal areas of the first substrate and a contact surface area of the second substrate being performed by means of a partial fusion of the spacing metallizations.

2. The process according to claim 1, wherein the spacing metallizations are partially fused by means of application of laser energy to the spacing metallizations.

3. The process according to claims 1, wherein the terminal areas of the first substrate are provided with an intermediate metallization prior to applying solder material.

4. The process according to claims 1, wherein the spacing metallizations are given a spherical shape.

5. The process according to claims 1, wherein the adhesive compound is applied to the spacing metallizations.

6. The process according to claims 1 wherein the adhesive compound is applied to contact areas of the second substrate provided for bonding to the spacing metallizations.

7. The process according to claim 5, wherein the adhesive compound is applied by means of in application device which can be moved relative to the spacing metallizations.

8. The process according to claim 5, wherein the adhesive compound is applied by immersing the spacing metallizations in a volume of the conductive adhesive compound.

9. The process according to claim 1, wherein, to produce the contact structure, the first substrate with its spacing metallizations is positioned against the contact surface of the second substrate with interposition of the conductive adhesive mass.

10. The process according to claims 1, wherein a gap remaining between the substrate surfaces after bonding the two substrates is filled with a filler material.

11. The process according to claim 10, wherein the filler material serves to secure the mechanical joint between the first substrate and second substrate.
